(19) United States
(12) Patent Application Publication
(10) Pub. No.: US 2009/0019114 A1
(43) Pub. Date: Jan. 15, 2009

(54) MANAGEMENT SYSTEM, MANAGEMENT METHOD AND CONTROL PROGRAM

(75) Inventors: Yuuichi Goto, Tokyo (JP); Tatsuyoshi Haga, Tokyo (JP)

Correspondence Address: CANTOR COLBURN, LLP, 20 Church Street, 22nd Floor, Hartford, CT, 06103, US

(73) Assignee: KONICA MINOLTA BUSINESS TECHNOLOGIES, INC., Tokyo (JP)

(21) Appl. No.: 12/140,486

(22) Filed: Jun. 17, 2008

(30) Foreign Application Priority Data
Jul. 9, 2007 (JP) JP2007-179360

(51) Int. Cl. G06F 15/16

(52) U.S. Cl. 709/205

(57) ABSTRACT

There is described a management system, which makes it possible to cope with a plurality of communication methods without complicating the system configuration. The system includes a first managed apparatus, a second managed apparatus and a management apparatus. The management apparatus includes: a first data processing section to conduct a conversion processing between management data and common data having such a format that conforms with the first communication method and that is available for the second communication method; and a second data processing section to conduct another conversion processing between the common data and communication data having such a format that conforms with the second communication method. Further, the management apparatus employs the common data to conduct the data communication with the first managed apparatus, while employs the communication data to conduct the data communication with the second managed apparatus.

This application is based on Japanese Patent Application NO. 2007-179360 filed on Jul. 9, 2007, with Japan Patent Office, the entire content of which is hereby incorporated by reference.

### BACKGROUND OF THE INVENTION

The present invention relates to a management system, a management method and a control program, and specifically relates to management method and system in which data communicating operations to be implemented between a management apparatus and a managed apparatus (apparatus to be managed) are actually conducted by employing plural kinds of communication methods, and a control program to be executed in such the management method and system.

In recent years, there have been increasingly proliferated in the market, a copier, a MFP (Multi Function Peripheral), etc., each of which is provided with a copy function, a facsimile function, a printer function, a scanner function, etc., (hereinafter, referred to as an image forming apparatus as a general term for each of them). Since an operating ratio of such the image forming apparatus is relatively high and it is necessary for the user to periodically apply maintenance and inspection processing to such the image forming apparatus due to a wide variety of consumable parts used for such the image forming apparatus, the image forming apparatus, serving as the managed apparatus, is coupled to the management apparatus through a certain communication network, so that the management apparatus acquires management information, such as a number of paper sheets to be printed, a usage frequency, a maintenance history, a history of operations for changing various kinds of parts, etc., from the image forming apparatus concerned, so as to conduct operations for managing the image forming apparatus concerned, based on the management information acquired.

Conventionally, there has been employed such a method that the image forming apparatus and the management apparatus are coupled to each other through a conventional telephone line network and, in response to the telephone call from the management apparatus, the image forming apparatus notifies the management apparatus of current statuses of its own, as the method for acquiring the management information from the image forming apparatus concerned. However, as for the abovementioned method, there has been such a problem that an ISDN (Integrated Services Digital Network) or the like should be employed as the telephone line network, resulting in a lack of a general purpose versatility of the system.

To solve the abovementioned problem, alternatively employed is such a method that the image forming apparatus and the management apparatus are coupled to each other through a communication network such as an Internet or the like, so that the image forming apparatus itself creates an electronic mail (hereinafter, referred to as an E-mail) in which current statuses of its own are described, in response to the E-mail received from the management apparatus, and sends the created E-mail back to the management apparatus.

For instance, Tokkai 2002-55796 (Japanese Non-Examined Patent Publication) sets forth such a remote managing system that comprises: an image forming apparatus serving as a managed apparatus; a management apparatus to manage the image forming apparatus; a network through which information are communicated between the image forming apparatus and the management apparatus; and a POP (Post Office Protocol) server to store the information therein, when the image forming apparatus transmits the information to the management apparatus. In the remote managing system abovementioned, the image forming apparatus, currently intending to acquire the information, accesses the POP server to acquire the information therefrom, while makes the time interval between the operations for accessing the POP server changeable.

In order to receive the E-mail, however, it is necessary to create a POP account for each of the image forming apparatuses included in the system. This makes the setup operation to be conducted in the customer's site cumbersome, and a certain customer would not desire to create the POP account for his image forming apparatus. Accordingly, although desired has been a proposal of such a system that the management information can be acquired by using a method other than the E-mail method, there arises problems that, when employing the method other than the E-mail method, it becomes impossible to conduct data communications with the management apparatus or the image forming apparatus, which employs the E-mail method, while, when installing individual functions to cope with each of various kinds of communication methods, the configuration of the management apparatus or the image forming apparatus becomes complicated, resulting in a cost increase of the system.

### SUMMARY OF THE INVENTION

To overcome the abovementioned drawbacks in conventional image forming apparatus, it is one of objects of the present invention to provide a management system, a management method and a control program, each of which makes it possible to cope with a plurality of communication methods without complicating the system configuration, even if the plurality of communication methods are intermingled in the system concerned.

Accordingly, at least one of the objects of the present invention can be attained by any one of the management system, the management method and the control program described as follows.
(1) According to a management system reflecting an aspect of the present invention, the management system, comprises: a first managed apparatus that conducts a data communicating operation in a first communication method, a second managed apparatus that conducts another data communicating operation in a second communication method; a management apparatus that is applicable for both the first communication method and the second communication method, and that employs management data to manage at least one or both of the first managed apparatus and the second managed apparatus; and a communication network through which the first managed apparatus, the second managed apparatus and the management apparatus are coupled to each other; wherein the management apparatus includes: a first data processing section to conduct a conversion processing between the management data and common data having such a format that conforms with the first communication method and that is available for the second communication method; and a second data processing section to conduct another conversion processing between the common data and communication data having such a format that conforms with the second communication method; and wherein the management apparatus employs the common data, to conduct the data communicating operation with the first managed apparatus, while the management apparatus employs the communication data, to conduct the other data communicating operation with the second managed apparatus.
(2) According to a management system reflecting another aspect of the present invention, the management system, comprises: a first management apparatus that conducts a data communicating operation in a first communication method; a second management apparatus that conducts another data communicating operation in a second communication method; a managed apparatus that is applicable for both the first communication method and the second communication method, and that is managed by management data employed by at least one or both of the first management apparatus and the second management apparatus; and a communication network through which the first management apparatus, the second management apparatus and the managed apparatus are coupled to each other; wherein the managed apparatus includes: a first data processing section to conduct a conversion processing between the management data and common data having such a format that conforms with the first communication method and that is available for the second communication method; and a second data processing section to conduct another conversion processing between the common data and communication data having such a format that conforms with the second communication method; and wherein the managed apparatus employs the common data, to conduct the data communicating operation with the first management apparatus, while the managed apparatus employs the communication data, to conduct the other data communicating operation with the second management apparatus.
(3) According to another aspect of the present invention, in the management system recited in item 1 or 2, each of the first communication method and the second communication method is any one of a communication method for exchanging E-mails between a sender and a receiver, another communication method for conducting data write/read operations based on an HTTP (Hypertext Transfer Protocol) and still another communication method for conducting data transferring operation based on a FTP (File Transfer Protocol).
(4) According to still another aspect of the present invention, in the management system recited in item 1 or 2, the first communication method is a communication method for exchanging E-mails between a sender and a receiver, while the second communication method is another communication method for conducting data write/read operations based on an HTTP (Hypertext Transfer Protocol); and the common data is such data that is in conformity with an E-mail format
(5) According to still another aspect of the present invention, in the management system recited in item 1 or 2, at least one of the first data processing section and the second data processing section is configured as a module.
(6) According to a management method reflecting still another aspect of the present invention, the management method to be employed in a management system, which includes: a first managed apparatus that conducts a data communicating operation in a first communication method; a second managed apparatus that conducts another data communicating operation in a second communication method; a management apparatus that is applicable for both the first communication method and the second communication method, and that employs management data to manage at least one or both of the first managed apparatus and the second managed apparatus; and a communication network through which the first managed apparatus, the second managed apparatus and the management apparatus are coupled to each other; wherein the management method to be implemented by the management apparatus comprises: creating the management data; converting the management data to common data having such a format that conforms with the first communication method and that is available for the second communication method; converting the common data to communication data having such a format that conforms with the second communication method; and transmitting the common data to the first managed apparatus, while transmitting the communication data to the second managed apparatus.
(7) According to a management method reflecting still another aspect of the present invention, the management method to be employed in a management system, which includes: a first management apparatus that conducts a data communicating operation in a first communication method; a second management apparatus that conducts another data communicating operation in a second communication method; a managed apparatus that is applicable for both the first communication method and the second communication method, and that is managed by management data employed by at least one or both of the first management apparatus and the second management apparatus; and a communication network through which the first management apparatus, the second management apparatus and the managed apparatus are coupled to each other; wherein the management method to be implemented by the managed apparatus comprises: receiving common data, having such a format that conforms with the first communication method and that is available for the second communication method, from the first management apparatus; converting the common data to the management data created by the first management apparatus; recording management information of the managed apparatus itself into the management data so as to create revised management data; converting the revised management data to revised common data; and transmitting the revised common data to the first management apparatus; and wherein the management method to be implemented by the first management apparatus comprises: receiving the revised common data converting the revised common data to the revised management data; and acquiring the management information from the revised management data.
(8) According to a management method reflecting still another aspect of the present invention, the management method to be employed in a management system, which includes: a first management apparatus that conducts a data communicating operation in a first communication method; a second management apparatus that conducts another data communicating operation in a second communication method; a managed apparatus that is applicable for both the first communication method and the second communication method, and that is managed by management data employed by at least one or both of the first management apparatus and the second management apparatus; and a communication network through which the first management apparatus, the second management apparatus and the managed apparatus are coupled to each other; wherein the management method to be implemented by the managed apparatus comprises: receiving communication data, having such a format that conforms with the second communication method, from the second management apparatus; converting the communication data to common data, having such a format that conforms with the first communication method and that is available for the second communication method; converting the common data to the management data created by the second management apparatus; recording management information of the managed apparatus itself into the management data so as to create revised management data; converting the revised management data to revised common data; converting the revised common data to revised communication data; and transmitting the revised communication data to the second management apparatus; and wherein the management method to be implemented by the second management apparatus comprises: receiving the revised communication data; converting the revised communication data to the revised management data; and acquiring the management information from the revised management data.
(9) According to a computer readable storage medium reflecting still another aspect of the present invention, the computer readable storage medium storing a computer executable program to be executed in a management apparatus included in a management system, which comprises: a first managed apparatus that conducts a data communicating operation in a first communication method; a second managed apparatus that conducts another data communicating operation in a second communication method; the management apparatus that is applicable for both the first communication method and the second communication method, and that employs management data to manage at least one or both of the first managed apparatus and the second managed apparatus; and a communication network through which the first managed apparatus, the second managed apparatus and the management apparatus are coupled to each other, the program being executable by a computer to cause the computer to perform a process comprises: conducting a conversion processing between the management data and common data having such a format that conforms with the first communication method and that is available for the second communication method; and conducting another conversion processing between the common data and communication data having such a format that conforms with the second communication method.
(10) According to a computer readable storage medium reflecting yet another aspect of the present invention, the computer readable storage medium storing a computer executable program to be executed in a managed apparatus included in a management system, which comprises; a first management apparatus that conducts a data communicating operation in a first communication method; a second management apparatus that conducts another data communicating operation in a second communication method; the managed apparatus that is applicable for both the first communication method and the second communication method, and that is managed by management data employed by at least one or both of the first management apparatus and the second management apparatus; and a communication network through which the first management apparatus, the second management apparatus and the managed apparatus are coupled to each other, the program being executable by a computer to cause the computer to perform a process comprises: conducting a conversion processing between the management data and common data having such a format that conforms with the first communication method and that is available for the second communication method; and conducting another conversion processing between the common data and communication data having such a format that conforms with the second communication method.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a schematic diagram indicating a configuration of a management system embodied in the present invention;

FIG. 2 shows a block diagram indicating a configuration of a management apparatus embodied in the present invention;

FIG. 3 shows a block diagram indicating a configuration of an image forming apparatus embodied in the present invention;

FIG. 4 shows a block diagram indicating a configuration of an image forming apparatus embodied in the present invention;

FIG. 5 shows a schematic diagram indicating another configuration of a management system embodied in the present invention;

FIG. 6 shows a block diagram indicating another configuration of a management apparatus embodied in the present invention;

FIG. 7 shows a block diagram indicating still another configuration of a management apparatus embodied in the present invention;

FIG. 8 shows a block diagram indicating another configuration of an image forming apparatus embodied in the present invention;

FIG. 9 shows a schematic diagram indicating a processing flow to be conducted in a management system embodied in the present invention;

FIG. 10 shows a flowchart indicating a procedure in such a case that a management apparatus, embodied in the present invention, requests an image forming apparatus to acquire management information;

FIG. 11 shows a flowchart indicating a procedure in such a case that a management apparatus, embodied in the present invention, acquires management information sent from an image forming apparatus;

FIG. 12(a) and FIG. 12(b) show examples of data structures of management data created by a management apparatus, embodied in the present invention, and common data acquired by converting the management data concerned; and

FIG. 13(a), and FIG. 13(b) show examples of data structures of management data processed by a management apparatus, embodied in the present invention, and a response mail acquired by converting the management data concerned.

### DETAILED DESCRIPTION OF THE PREFERRED EMBODIMENT

As shown in the “BACKGROUND OF THE INVENTION”, in order to manage the image forming apparatus, there has been utilized such the method that the image forming apparatus and the management apparatus are coupled to each other through a communication network, so as to exchange E-mails between the image forming apparatus and the management apparatus through a mail server, such as a POP server, a SMTP (Simple Mail Transfer Protocol) server, etc., (hereinafter, referred to as the E-mail method). However, in the E-mail method, since it is necessary to established a POP account for each of the image forming apparatuses residing in the system concerned, many man-hours has been required for the setup operation of the image forming apparatus, and some users have been worried about a security aspect of the image forming apparatus concerned.

To overcome the abovementioned drawbacks in the conventional system, proposed as the first feature of the present invention is a method in which data read/write operations from/to each of the management apparatus and the image forming apparatuses are conducted by using an HTTP (Hypertext Transfer Protocol) server, such as a Web-DAV (Distributed Authoring and Versioning protocol for the WWW) server, etc., (hereinafter, referred to as an HTTP method). Since this HTTP method requires only a single Web server provided by a service center, etc., and requires no establishment of account, it is possible to solve the abovementioned problems.

However, when the image forming apparatuses and the management apparatus, which employ the abovementioned HTTP method, are installed into the management system, there arises another problem that it becomes impossible for each of them to conduct data communications with other image forming apparatuses and another management apparatus, which employ the E-mail method. To solve this problem, proposed as the second feature of the present invention is to provide a function, for making it possible to cope with both the E-mail method and the HTTP method, into at least one of the image forming apparatuses or the management apparatus. Concretely speaking, the concerned apparatus conducts the data read/write operations from/to an apparatus that employs the E-mail method, based on the SMTP, a POP, etc., while from/to an apparatus that employs the HTTP method, based on the HTTP.

In this connection, if the function corresponding to the E-mail method and the other function corresponding to the HTTP method are separately installed into the concerned apparatus for the abovementioned purpose, the configuration of the concerned apparatus becomes complicated, and the complicated configuration causes a cost increase of the concerned apparatus. To avoid such cost increase, proposed as the third feature of the present invention is to structure the abovementioned function with: a first data processing section that conducts a conversion processing between the management data for managing the image forming apparatus and data in such a format that complies with one of the communication methods, and is available for the other one of the communication methods (hereinafter, referred to as common data); and a second data processing section that conducts another conversion processing between the common data and communication data that complies with the other one of the communication methods. Further, as the third feature of the present invention, the first data processing section is configured as a module, or the first data processing section and the second processing section are configured as control programs, so as to operate them on the image forming apparatus and the management apparatus.

According to the above, it becomes possible to conduct the data communication by using the communication method suitable for the communication partner, while simplifying the configuration of the image forming apparatus or the management apparatus, and accordingly, it also becomes possible for the management apparatus to securely manage each of the image forming apparatuses coupled to the system.

In this connection, although the present invention is applicable for an arbitral management system in which plural communication methods, based on various protocols being different from each other, are intermingled, and the common data, represented in the format commonly available in the plural communication methods, can be created, such the case that the present invention is applied to the management system, in which the E-mail method and the HTTP method are intermingled, will be detailed in the following.

### Embodiment

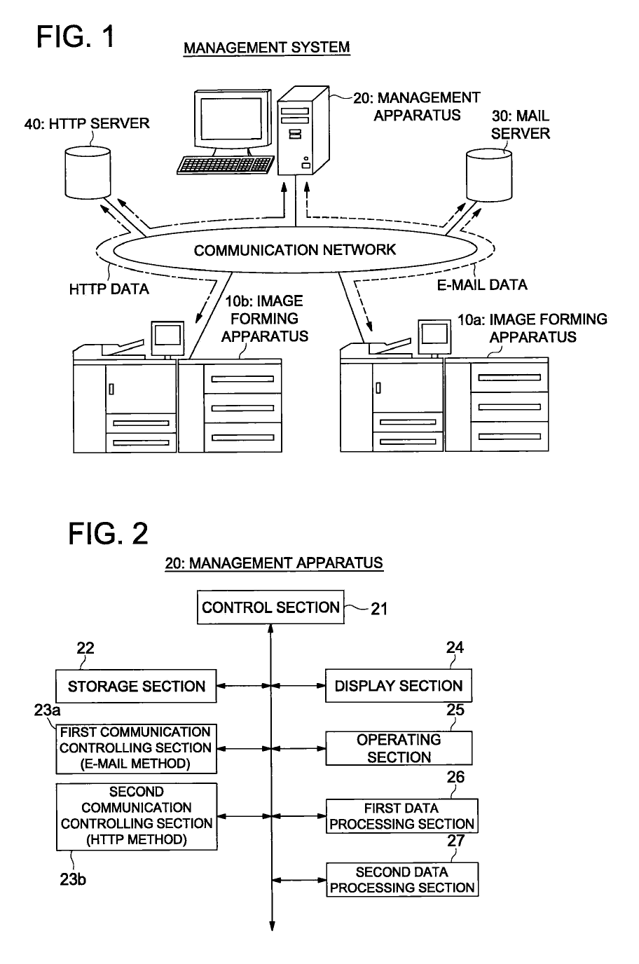

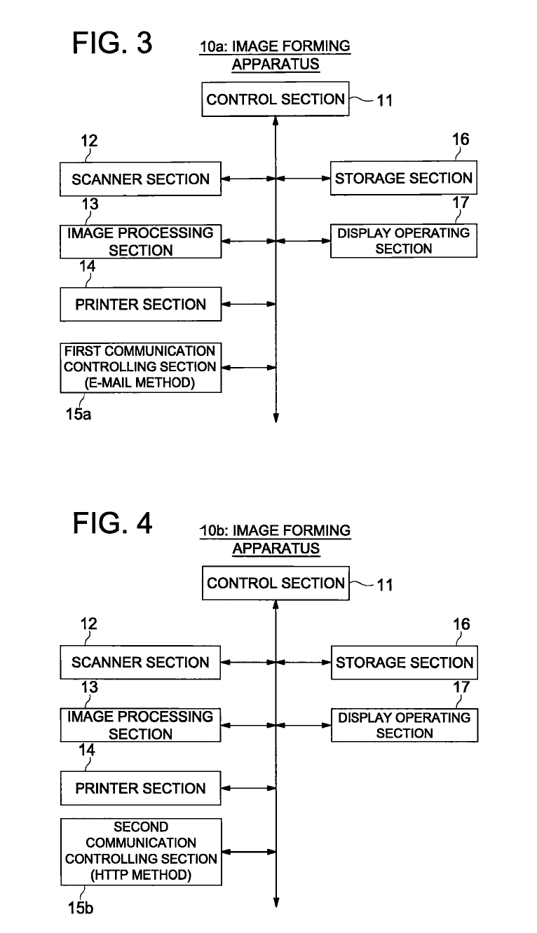

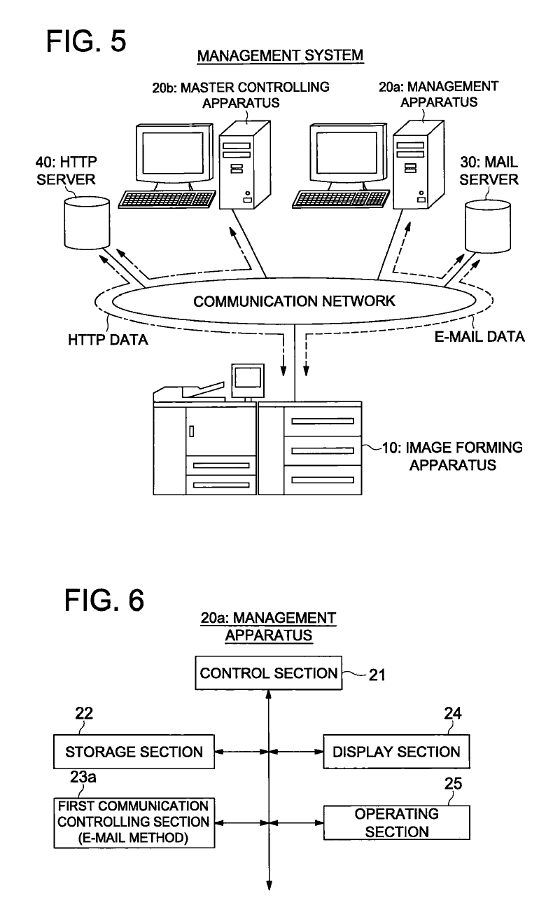

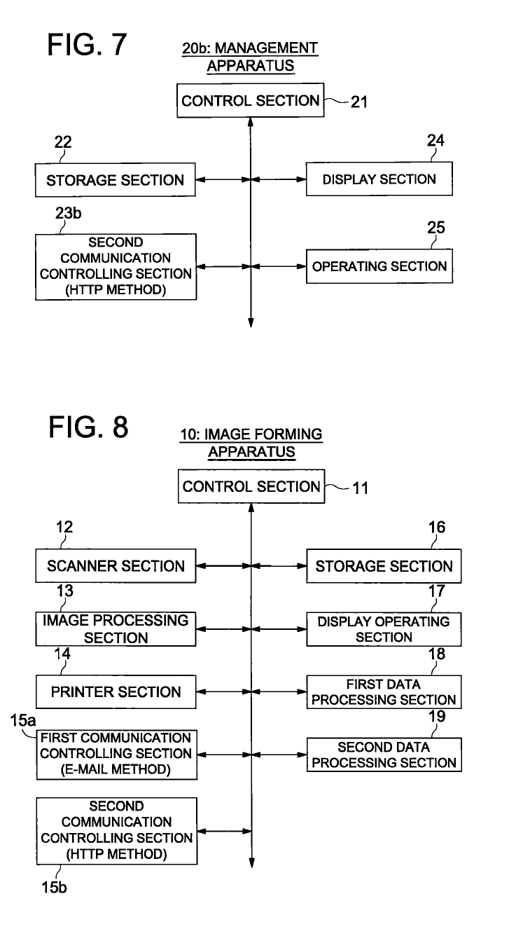

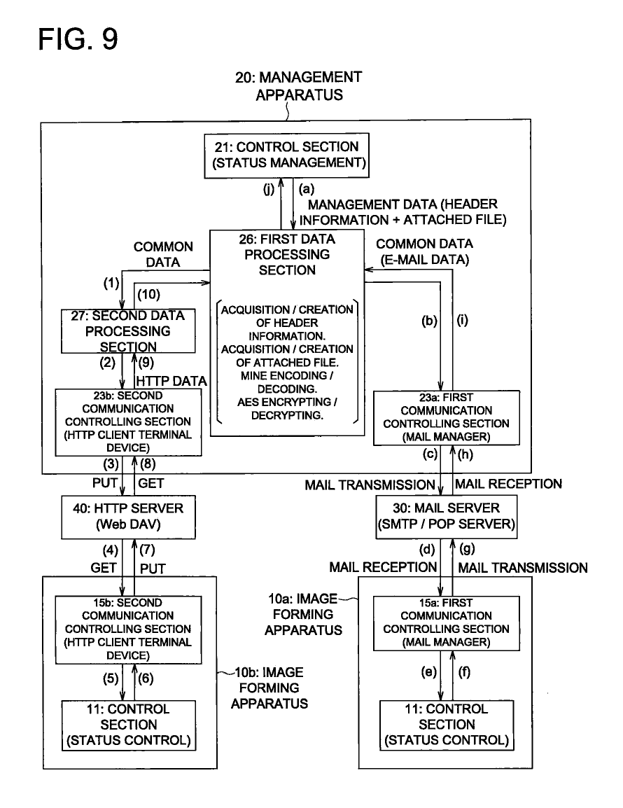

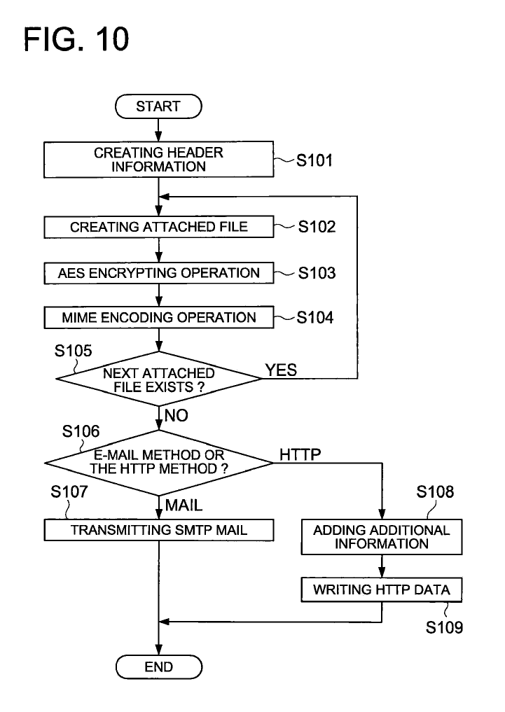

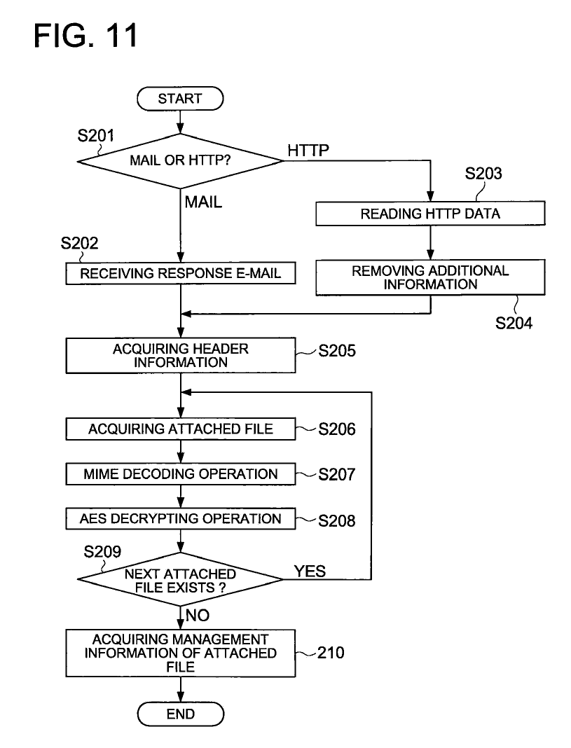

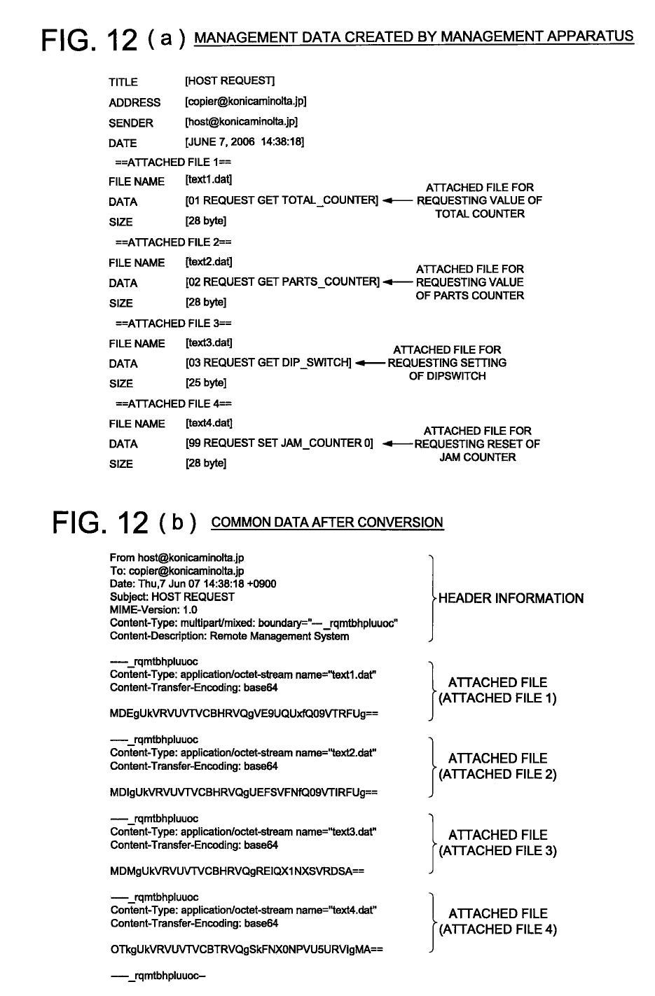

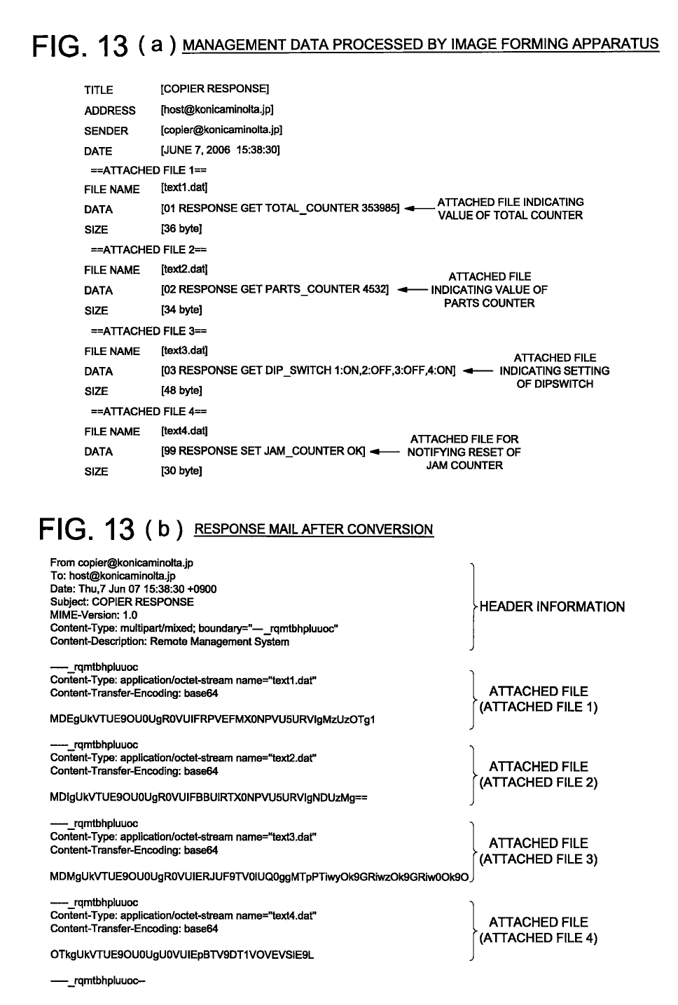

In order to describe the preferred embodiment of the present invention in detail, referring to FIG. 1 through FIG. 13, a management system, a management method and a control program, embodied in the present invention, will be detailed in the following. FIG. 1 and FIG. 5 show schematic diagrams indicating configurations of the management systems embodied in the present invention. Further, FIG. 2, FIG. 6 and FIG. 7 show block diagrams indicating configurations of the management systems embodied in the present invention, while FIG. 3, FIG. 4 and FIG. 8 show block diagrams indicating configurations of the image forming apparatuses embodied in the present invention. Still further, FIG. 9 shows a block diagram indicating a processing flow to be conducted in the management system embodied in the present invention, while FIG. 10 and FIG. 11 show flowcharts indicating managing procedures to be implemented in the management system embodied in the present invention. Yet further, FIG. 12(a), FIG. 12(b), FIG. 13(a), and FIG. 13(b) show examples of data structures to be employed in the embodiment of the present invention.

The management system embodied in the present invention is constituted by a single or a plurality of image forming apparatus(es), each serving as a managed apparatus, and a single or a plurality of management apparatus(es) for managing the single or the plurality of image forming apparatus(es), which are coupled to each other through communication network, such as a LAN (Local Area Network), a WAN (Wide Area Network), etc. In the management system, the data communications between them are implemented under such an environment that a first communication method based on a first protocol and a second communication method based on a second protocol, which are different from each other, are intermingled. The operating modes of the management system can be divided broadly into the first mode shown in FIG. 1 and the second mode shown in FIG. 5. Each of the first mode and the second mode will be detailed in the following.

In this connection, although the first communication method is defined as the E-mail method and the second communication method is defined as the HTTP method in the following descriptions, it is also applicable that any other communication method is employed as either the first communication method or the second communication method, as far as the protocol used in the first communication method is different from that used in the second communication method, and both methods have a common part in the data to be communicated between them. For instance, other than the E-mail method and the HTTP method, a plurality of communication methods selected from various kinds of communication methods, such as a method employing an HTTPS (Hypertext Transfer Protocol Security) being a protocol created by attaching a data encrypting function, which complies with the SSL (Secure Socket Layer), to the HTTP, a method employing the FTP (File Transfer Protocol) being a protocol to be used at the time when transferring a file through the TCP/IP (Transmission Control Protocol/Internet Protocol) network, etc., are also applicable in the present invention, as well.

### First Embodiment

As shown in FIG. 1, in the management system embodied in the present invention as the first embodiment, an image forming apparatus 10a that employs the E-mail method to conduct data communicating operations, an image forming apparatus 10b that employs the HTTP method to conduct the data communicating operations and a management apparatus 20 that is applicable for both the E-mail method and the HTTP method, are coupled to each other through a communication network. Further, a mail server 30, such as the SMTP server and the POP server, an IMAP (Internet Message Access Protocol) server, etc., and an HTTP server 40, such as the Web-DAV, etc., are also coupled to the communication network. In this connection, although a single unit of the management apparatus 20 and plural units of the image forming apparatuses 10a and 10b are shown in FIG. 1, it is also applicable that the management system is so constituted that plural units of the management apparatuses and/or three or more units of the image forming apparatuses are coupled to the communication network.

As shown in FIG. 2, the management apparatus 20 abovementioned is provided with a control section 21, a storage section 22, a first communication controlling section 23a, a second communication controlling section 23b, a display section 24, an operating section 25, a first data processing section 26, a second data processing section 27, etc.

The control section 21 is constituted by a CPU (Central Processing Unit), a ROM (Read Only Memory), a RAM (Random Access Memory), etc. In response to operating actions conducted on the operating section 25, the CPU reads out various kinds of programs stored in the ROM and develops them into the RAM, so as to control each of the sections provided in the management apparatus 20, according to the programs developed on the RAM, and at the same time, manages the statuses of the image forming apparatus 10a and the image forming apparatus 10b.

The storage section 22 is constituted by a flash memory, an HDD (Hard Disc Drive), etc., so as to store various kinds of data. Specifically in this first embodiment, the storage section 22 stores such data that represents information for managing the image forming apparatus, such as a total number of printed paper sheets, a number of printed paper sheets for every size, a usage frequency, a maintenance history, a parts changing history, etc., (hereinafter, referred to as management information) therein.

The first communication controlling section 23a conducts controlling operations for transmitting an E-mail to the mail server 30 (SMTP server) being an external apparatus, and for receiving an E-mail sent from the mail server 30 (POP server). Further, the first communication controlling section 23a also serves as a mailing manager that conducts direction processing of the transmitted E-mails and the received E-mails.

The second communication controlling section 23b conducts controlling operations for writing data into the HTTP server 40 (Web-DAV server) being an external apparatus, and for reading data from the HTTP server 40 (Web-DAV server). Namely, the second communication controlling section 23b serves as an HTTP client terminal device.

The display section 24 is constituted by a LCD (Liquid Crystal Display), an Organic ELD (Electroluminescence Display), etc., so as to display various kinds of managing screens, etc., based on display signals sent from the control section 21. Further, the operating section 25 is constituted by a keyboard, a mouse, etc., so as to conduct operations for selecting the communication method to be applied to each of the image forming apparatuses, etc.

The first data processing section 26 conducts a conversion processing between data representing the management information (hereinafter, referred to as management data) and common data that is in conformity with the communication method (herein, the E-mail method) and is also available in the other communication method (herein, the HTTP method). In this first embodiment, the common data is made to comply with the E-mail method, and the first data processing section 26 conducts various kinds of processing, such as an operation for acquiring or creating header information of the E-mail, an operation for acquiring or creating body information (including an attached file) of the E-mail, an encoding or decoding operation in conformity with the MIME (Multipurpose Internet Mail Extension), an encrypting or decrypting operation based on the AES (Advanced Encryption Standard), and other processing.

The second data processing section 27 conducts a conversion processing between the common data and communication data in conformity with the other communication method (herein, the HTTP method). In this first embodiment, since the common data is made to comply with the E-mail method, only when the HTTP method is employed, the second data processing section 27 conducts processing for adding the additional information, such as a time, a URL (Uniform Resource Locator), a data size etc., to the common data, so as to convert the common data to the communication data in conformity with the HTTP method (hereinafter, referred to as HTTP data), or for removing the additional information from the HTTP data, so as to convert the HTTP data to the common data, and other processing. In this connection, when the format of the common data is not available for the other communication method as it is, the second data processing section 27 conducts an operation for conversing the common data concerned to the communication data in conformity with each of the communication methods.

Although the first data processing section 26 and the second data processing section 27 can be either separately or integrally configured in the apparatus, by making the first data processing section 26 to be formed as a module, it becomes possible not only to simplify the configuration of the management apparatus 20, but also to make it comply with the general purpose. Further, it is applicable that each of the first data processing section 26 and the second data processing section 27 can be configured as hardware, or alternatively, configured as a control program, which makes a computer serve as either the first data processing section 26 or the second data processing section 27, so as to execute the concerned program in the control section 21.

Further, as shown in FIG. 3, the image forming apparatus 10a is provided with a control section 11, a scanner section 12, an image processing section 13, a printer section 14, a first communication controlling section 15a, a storage section 16, a display operating section 17, etc., while, as shown in FIG. 4, the image forming apparatus 10b is provided with a control section 11, a scanner section 12, an image processing section 13, a printer section 14, a second communication controlling section 15b, a storage section 16, a display operating section 17, etc.

The control section 11 is constituted by a CPU, a ROM, a RAM, etc. In response to operating actions conducted on the display operating section 17, the CPU reads out various kinds of programs stored in the ROM and develops them into the RAM, so as to control each of the sections provided in the image forming apparatus 10 according to the programs developed on the RAM, and at the same time, manages the statuses of each of the sections. Further, the control section 11 conducts processing for: decoding the contents of the E-mail sent from the management apparatus 20; applying the MIME decoding operation so as to convert the decoded data to the management data; recording the management data into the attached file; encrypting the attached file; and applying the MIME encoding operation so as to convert the management data to the E-mail.

The scanner section 12 is constituted by a light source to emit a light beam that is scanned on a document, a CCD (Charge Coupled Device) to convert the light beam reflected from the surface of the document to electric signals and an analogue to digital converter to convert the electric signals to the digital image data, so as to read the information recorded on the document.

The image processing section 13 applies various kinds of image processing operations, such as an image size expansion or compression processing, a rotation processing, a color conversion processing form RGB data to YMCK data, a gradation correction processing, to the digital image data generated by the scanner section 12 (hereinafter, referred to as scanned image data).

The printer section 14 is provided with: an image forming section to form a toner image to be transferred onto a transfer material; a transferring section to transfer the toner image formed by the image forming section onto the transfer material; a fixing section to fix the toner image, transferred by the transferring section, onto the transfer material; a conveyance section to convey the transfer material; cleaning sections to clean the image forming section, the transferring section and the fixing section, respectively; etc., so as to form a reproduced image based on the inputted image data onto the transfer material through the electro-photographic process, and outputs the transfer material on which the reproduced image is formed. In addition to the above, the printer section 14 is further provided with a counter to count a number of printed transfer materials for every size of the transfer material, so as to transmit the management information, such as a total number of printed sheets, a number of printed sheets for every size, etc., to the control section 11.

The first communication controlling section 15a of the image forming apparatus 10a conducts controlling operations for transmitting an E-mail to the mail server 30 (SMTP server) being an external apparatus, and for receiving an E-mail sent from the mail server 30 (POP server). Further, the first communication controlling section 15a also serves as a mailing manager that conducts direction processing of the transmitted E-mails and the received E-mails.

The second communication controlling section 15b of the image forming apparatus 10b conducts controlling operations for writing data into the HTTP server 40 (Web-DAV server) being an external apparatus, and for reading data from the HTTP server 40 (Web-DAV server). Namely, the second communication controlling section 15b serves as an HTTP client terminal device.

The storage section 16 is constituted by a flash memory, an HDD (Hard Disc Drive), etc., so as to store various kinds of data, setting conditions, etc., therein. Specifically in this first embodiment, the storage section 16 stores such data that represents the management information, such as a total number of printed paper sheets, a number of printed paper sheets for every size, a usage frequency of the apparatus as a whole, usage frequencies of parts employed in the apparatus, a maintenance history, a parts changing history, etc., therein.

The display operating section 17 is formed by mounting a pressure-sensitive operating section (touch panel), in which transparent electrodes are aligned in a lattice pattern, onto a display section, such as a LCD (Liquid Crystal Display), an Organic Electroluminescence Display, etc., so as to make it possible to detect X-Y coordinates of a power point depressed by a finger, a touch pen, etc., as voltage values. The detected positional signals are to be outputted to the control section 11 as operational signals.

### Second Embodiment

As shown in FIG. 5, in the management system embodied in the present invention as the second embodiment, an image forming apparatus 10 that is applicable for both the E-mail method and the HTTP method, a management apparatus 20a that employs the E-mail method to conduct data communicating operations, and a management apparatus 20b that employs the HTTP method to conduct data the communicating operations, are coupled to each other through a communication network. Further, a mail server 30, such as the SMTP server and the POP server, an IMAP (Internet Message Access Protocol) server, etc., and an HTTP server 40, such as the Web-DAV, etc., are also coupled to the communication network. In this connection, although two units of the management apparatuses 20a, 20b and a single unit of the image forming apparatuses 10 are indicated in FIG. 5, it is also applicable that the management system is so constituted that three or more units of the management apparatuses and/or plural units of the image forming apparatuses are coupled to the communication network.

Further, as shown in FIG. 6, the management apparatus 20a abovementioned is provided with a control section 21, a storage section 22, a first communication controlling section 23a, a display section 24, an operating section 25, etc., while, as shown in FIG. 7, the management apparatus 20b abovementioned is provided with a control section 21, a storage section 22, a second communication controlling section 23b, a display section 24, an operating section 25, etc. The control section 21 conducts processing for: encrypting the attached file; applying the MIME encoding operation so as to convert the management data to the E-mail; decoding the contents of the E-mail sent from the image forming apparatus 10; applying the MIME decoding operation so as to convert the decoded data to the management data; and acquiring the management data recorded in the attached file; so as to control the image forming apparatus 10. Incidentally, since the operations of the other sections are the same as those in the first embodiment, explanations of them will be omitted in the following.

Still further, as shown in FIG. 8, the image forming apparatus 10 is provided with a control section 11, a scanner section 12, an image processing section 13, a printer section 14, a first communication controlling section 15a, a second communication controlling section 15b, a storage section 16, a display operating section 17, a first data processing section 18, a second data processing section 19, etc. In other words, the image forming apparatus 10 of the second embodiment is characterized in that it is provided the first communication controlling section 15a and the second communication controlling section 15b, and further provided with the first data processing section 18 and the second data processing section 19.

The first data processing section 18 conducts a conversion processing between the management data representing the management information and common data that is in conformity with the communication method (herein, the E-mail method) and is also available in the other communication method (herein, the HTTP method). In this second embodiment, the common data is made to comply with the E-mail method, and the first data processing section 26 conducts various kinds of processing, such as an operation for acquiring or creating header information of the E-mail, an operation for acquiring or creating body information (including an attached file) of the E-mail, an encoding or decoding operation in conformity with the MIME (Multipurpose Internet Mail Extension), an encrypting or decrypting operation based on the AES, and other processing.

The second data processing section 19 conducts a conversion processing between the common data and communication data in conformity with the other communication method (herein, the HTTP method). In this second embodiment, since the common data is made to comply with the E-mail method, only when the HTTP method is employed, the second data processing section 27 conducts processing for adding the additional information, such as a time, a URL, a data size etc., to the common data, so as to convert the common data to the HTTP data in conformity with the HTTP method, or for removing the additional information from the HTTP data, so as to convert the HTTP data to the common data, and other processing. In this connection, when the format of the common data is not available for the other communication method as it is, the second data processing section 19 conducts an operation for conversing the common data concerned to the communication data in conformity with each of the communication methods.

Although the first data processing section 18 and the second data processing section 19 can be either separately or integrally configured in the apparatus, by making the first data processing section 18 to be formed as a module, it becomes possible not only to simplify the configuration of the image forming apparatus 10, but also to make it comply with the general purpose. Further, it is applicable that each of the first data processing section 18 and the second data processing section 19 can be configured as hardware, or alternatively, configured as a control program, which makes a computer serve as either the first data processing section 18 or the second data processing section 19, so as to execute the concerned program in the control section 11.

In this connection, although the computer terminal device is employed as the management apparatus in the system configuration shown in FIG. 1 and FIG. 5, an arbitral type apparatus can be configured as the management apparatus. Further, although each of the image forming apparatuses, shown in FIG. 3, FIG. 4 and FIG. 8, is defined as the Multi Function Peripheral that is provided with the scanner section 12, the image processing section 13 and the printer section 14, it is also applicable that a single functional apparatus, such as a scanner, a printer, a copier, etc., is employed as the image forming apparatus concerned, or the Multi Function Peripheral is further provided with an ADF (Auto Document Feeder), post processing devices, such as a puncher, a stapler, a binding stopper, etc.

Further, although any one of the management apparatus and the image forming apparatus is provided with the first data processing section and the second data processing section in the system configuration shown in FIGS. 1 through 8, such the configuration that each of the management apparatus and the image forming apparatus is provided with the first data processing section and the second data processing section is also applicable.

Next, the managing procedure to be implemented in the aforementioned management system (herein, the management system of the first embodiment) will be detailed in the following. Initially, referring to the block diagram shown in FIG. 9, the flowchart shown in FIG. 10 and the examples of data structures shown in FIG. 12(a), FIG. 12(b), FIG. 13(a), and FIG. 13(b), the procedure for requesting the management information from the management apparatus 20 to the image forming apparatuses 10a, 10b, will be detailed in the following.

At first, a manager operates the operating section 25 of the management apparatus 20 to input a title, an address, a sender, a date, etc., and at the same time, requests acquisition of the management information desired by the manager (herein, information in regard to a total counter, a parts counter, setting of a dipswitch, reset of jam counter). In response to the inputting operation conducted by the manager, the control section 21 creates such the management data as shown in FIG. 12(a), and then, transmits the created management data to the first data processing section 26 (refer to arrow (a) shown in FIG. 9).

Successively, the first data processing section 26 creates header information that is constituted by character strings of “From”, “TO”, “Date”, “Subject”, “MIME-Version”, “Content-Type”, “Content-Description”, etc., as shown in FIG. 12(b), and declares in the “Content-Description” that the mail concerned is the remote managing mail (Step S101).

Still successively, the first data processing section 26 acquires an attached file attached to the management data (herein, an attached file 1 for requesting acquisition of a counted value of the total counter), and converts the attached file into the predetermined format (herein, the E-mail format) (Step S102).

Still successively, the first data processing section 26 conducts the encrypting operation based on the AES (Step S103), and then, conducts the encoding operation in conformity with the MIME (Step S104). In this connection, the scope of the encrypting method or the encoding method is not specifically limited, and it would be possible to omit the encrypting operation.

Still successively, the first data processing section 26 determines whether or not a next attached file exists (Step S105). When determining that the next attached file exists (Step S105; Yes), the first data processing section 26 returns to Step S102 so as to sequentially acquire the next attached file, such as an attached file 2 for requesting acquisition of a counted value of the parts counter, an attached file 3 for acquiring setting of the dipswitch, an attached file 4 for requesting an operation for resetting the jam counter, from the management data, and then, conducts the encrypting operation and the encoding operation as well, so as to create the common data shown in FIG. 12(b). In this connection, although the AES encrypting operation and the MIME encoding operation are conducted for every attached file in the abovementioned embodiment, it is also applicable that the MIME decoding operation and/or the AES decrypting operation are applied to all of the attached files at a same time as batch processing.

Still successively, when determining that the next attached file does not exist (when the processing of the attached file, for which “99” is described in the data column of the management data, is completed) (Step S105; No), the first data processing section 26 refers to a table stored in advance in the storage section 22, so as to determine whether the image forming apparatus currently addressed employs the E-mail method or the HTTP method (Step S106).

When the image forming apparatus currently addressed employs the E-mail method (when the image forming apparatus currently addressed is the image forming apparatus 10a) (Step S106; E-mail), since the common data is available as the communication data of the E-mail method as it is in this embodiment, the common data is transmitted to the first communication controlling section 23a (refer to arrow (b) shown in FIG. 9), so that the first communication controlling section 23a transmits the common data (E-mail) to the mail server 30 (refer to arrow (c) shown in FIG. 9) (Step S107).

On the other hand, when the image forming apparatus currently addressed employs the HTTP method (when the image forming apparatus currently addressed is the image forming apparatus 10b) (Step S106; HTTP), since the common data, as it is, cannot be written into the HTTP server 40, the common data is transmitted to the second data processing section 27 (refer to arrow (1) shown in FIG. 9), so that the second data processing section 27 conducts processing for adding the additional information, such as a time, a URL, a data size etc., to the common data, so as to convert the common data to the HTTP data, and then, transmits the HTTP data to the second communication controlling section 23b (refer to arrow (2) shown in FIG. 9) (Step S108). Receiving the HTTP data, the second communication controlling section 23b writes the HTTP data into the HTTP server 40 (refer to arrow (3) shown in FIG. 9) (Step S109).

Still successively, in the image forming apparatus 10a, by using the first communication controlling section 15a, the E-mail is received from the mail server 30 and transmitted to the control section 11 (refer to arrow (d) and arrow (e), both shown in FIG. 9). Receiving the E-mail concerned, the control section 11 acquires the attached data from the E-mail by applying the MIME decoding operation and the AES decrypting operation to the E-mail concerned. Then, as shown in FIG. 13(a), the control section 11 writes the value of the total counter, the value of the parts counter, the setting information of the dipswitch and the reset completion notification of the jam counter, into the attached files (1) through (4), respectively, and again conducts the AES encrypting operation and the MIME encoding operation, so as to create a response E-mail as shown in FIG. 13(b), and then, transmits the response E-mail to the first communication controlling section 15a. Receiving the response E-mail concerned, the first communication controlling section 15a further transmits the response E-mail to the mail server 30 (refer to arrow (f) and arrow (g), both shown in FIG. 9).

On the other hand, in the image forming apparatus 10b, by using the second communication controlling section 15b, the HTTP data is read from the HTTP server 40 and transmitted to the control section 11 (refer to arrow (4) and arrow (5), both shown in FIG. 9). Receiving the HTTP data concerned, the control section 11 acquires the attached data by applying the MIME decoding operation and the AES decrypting operation to the HTTP data concerned. Then, the control section 11 writes the value of the total counter, the value of the parts counter, the setting information of the dipswitch and the reset completion notification of the jam counter, into the attached files (1) through (4), respectively, and again conducts the AES encrypting operation, the MIME encoding operation and the operation for adding the additional information, so as to create a revised HTTP data, and then, transmits the revised HTTP data to the second communication controlling section 15b. Receiving the revised HTTP data concerned, the second communication controlling section 15b writes the revised HTTP data into the HTTP server 40 (refer to arrow (6) and arrow (7), both shown in FIG. 9).

Next, referring to the block diagram shown in FIG. 9 and the flowchart shown in FIG. 11, a procedure that the management apparatus 20 acquires the management information from the image forming apparatuses 10a, 10b, will be detailed in the following.

When the management apparatus 20 receives the E-mail (Step S201; Mail), by using the first communication controlling section 23a, the management apparatus 20 receives the response E-mail sent from the mail server 30, and then, the response E-mail (common data) is transmitted from the first communication controlling section 23a to the first data processing section 26 (Step S202) (refer to arrow (h) and arrow (i), both shown in FIG. 9).

On the other hand, when the management apparatus 20 receives the HTTP data (Step S201; HTTP), by using the second communication controlling section 23b, the management apparatus 20 reads the HTTP data from the HTTP server 40, and then, the HTTP data is transmitted from the second communication controlling section 23b to the second data processing section 27 (Step S203) (refer to arrow (8) and arrow (9), both shown in FIG. 9). Then, the second data processing section 27 removes the additional information from the HTTP data concerned, so as to convert the HTTP data to the common data, and transmits the common data to the first data processing section 26 (Step S204) (refer to arrow (10), shown in FIG. 9).

Successively, the first data processing section 26 acquires the header information from the common data, so as to specify the image forming apparatus to be managed (Step S205).

Still successively, the first data processing section 26 acquires the attached file (attached file 1) (Step S206). Then, the first data processing section 26 conducts the MIME decoding operation (Step S207), and after that, conducts the AES decrypting operation (Step S208).

Still successively, the first data processing section 26 determines whether or not the next attached file exists (Step S209). When determining that the next attached file exists (Step S209; Yes), the first data processing section 26 returns to Step S206 so as to sequentially acquire the next attached file (attached file 2, attached file 3, attached file 4) from the management data, and then, conducts the MIME decoding operation and the AES decrypting operation as well, so as to convert the common data to the management data. In this connection, although the MIME decoding operation and the AES decrypting operation are conducted for every attached file in the abovementioned embodiment, it is also applicable that the MIME decoding operation and/or the AES decrypting operation are applied to all of the attached files at a same time as batch processing.

Yet successively, when determining that the next attached file does not exist (when the processing of the attached file, for which “99” is described in the data column of the management data, is completed) (Step S209; No), the first data processing section 26 transmits the management data to the control section 21 (refer to arrow (j), shown in FIG. 9). The control section 21 acquires the various kinds of management information of the image forming apparatus concerned (the value of the total counter=353985, the value of the parts counter=4532, the current status of dipswitch 1: ON, that of dipswitch 2: OFF, that of dipswitch 3: OFF, that of dipswitch 4: ON, the reset of the jam counter: completed) (Step S210), and manages the image forming apparatus concerned, based on the management information acquired in the above.

As described in the foregoing, in the managing system in which a single image forming apparatus or a plurality of image forming apparatuses and a single management apparatus or a plurality of management apparatuses are coupled to each other through a communication network, and plural communication methods are employed for conducting the data communicating operations between them, by installing a first data processing section and a second data processing section, each of which is formed as either hardware (preferably, a module) or software, into any one of the image forming apparatuses or the management apparatuses, it becomes possible not only to simplify the configuration of the system concerned, but also to make it comply with the general purpose. Further, in addition to the above, it also becomes possible to securely implement the data communicating operation with the apparatus that employs any kind of communication method, and accordingly, it becomes possible for the management apparatus to securely manage the image forming apparatus in the system.

Incidentally, although the image forming apparatus has been exemplified as the managed apparatus in the embodiments described in the foregoing, it is needless to say that the present invention can be also applied for such an arbitral apparatus that is capable of being coupled to the communication network, and capable of transmitting the management data by using any one of the various kinds of communication methods.

The present invention is available for a management system in which a management apparatus and a managed apparatus are coupled to each other through a communication network and a plurality of communication methods are intermingled, and for a management method to be employed in such the management system as abovementioned.

According to the management system and the management method embodied in the present invention, it becomes possible to cope with a plurality of communication methods without complicating the system configuration, even if the plurality of communication methods are intermingled with each other in the management system concerned.

This is because, in the management system in which the plurality of communication methods, based on respectively different protocols, are intermingled with each other, since, by installing the first data processing section and the second data processing section, each of which is formed as either hardware or software, into at least one of the management apparatus and the managed apparatus (image forming apparatus), the management system is so constituted that the first data processing section conducts the conversion processing between the management data for managing the image forming apparatus and the common data having such a format that is in conformity with one of the communication methods and that is available for the other communication method, while the second data processing section conducts the other conversion processing between the common data and the other communication data that is in conformity with the other communication method, and as needed, the first data processing section is configured as a module, it becomes possible to employ the communication method that is in conformity with that of the current communication partner, while simplifying the configurations of the management apparatus and the image forming apparatus serving as the managed apparatus.

While the preferred embodiments of the present invention have been described using specific term, such description is for illustrative purpose only, and it is to be understood that changes and variations may be made without departing from the spirit and scope of the appended claims.

What is claimed is:

1. A management system, comprising:
a first managed apparatus that conducts a data communicating operation in a first communication method;
a second managed apparatus that conducts another data communicating operation in a second communication method;
a management apparatus that is applicable for both the first communication method and the second communication method, and that employs management data to manage at least one or both of the first managed apparatus and the second managed apparatus; and
a communication network through which the first managed apparatus, the second managed apparatus and the management apparatus are coupled to each other;
wherein the management apparatus includes:
a first data processing section to conduct a conversion processing between the management data and common data having such a format that conforms with the first communication method and that is available for the second communication method; and
a second data processing section to conduct another conversion processing between the common data and communication data having such a format that conforms with the second communication method; and
wherein the management apparatus employs the common data, to conduct the data communicating operation with the first managed apparatus, while the management apparatus employs the communication data, to conduct the other data communicating operation with the second managed apparatus.

2. The management system of claim 1,
wherein each of the first communication method and the second communication method is any one of a communication method for exchanging E-mails between a sender and a receiver, another communication method for conducting data write/read operations based on an HTTP (Hypertext Transfer Protocol) and still another communication method for conducting data transferring operation based on a FTP (File Transfer Protocol),

3. The management system of claim 1,
wherein the first communication method is a communication method for exchanging E-mails between a sender and a receiver, while the second communication method is another communication method for conducting data write/read operations based on an HTTP (Hypertext Transfer Protocol); and
wherein the common data is such data that is in conformity with an E-mail format.

4. The management system of claim 1,
wherein at least one of the first data processing section and the second data processing section is configured as a module.

5. A management system, comprising:
a first management apparatus that conducts a data communicating operation in a first communication method;
a second management apparatus that conducts another data communicating operation in a second communication method;
a managed apparatus that is applicable for both the first communication method and the second communication method, and that is managed by management data employed by at least one or both of the first management apparatus and the second management apparatus; and
a communication network through which the first management apparatus, the second management apparatus and the managed apparatus are coupled to each other;
wherein the managed apparatus includes:
a first data processing section to conduct a conversion processing between the management data and common data having such a format that conforms with the first communication method and that is available for the second communication method; and
a second data processing section to conduct another conversion processing between the common data and communication data having such a format that conforms with the second communication method; and
wherein the managed apparatus employs the common data, to conduct the data communicating operation with the first management apparatus, while the managed apparatus employs the communication data, to conduct the other data communicating operation with the second management apparatus.

6. The management system of claim 5,
wherein each of the first communication method and the second communication method is any one of a communication method for exchanging E-mails between a sender and a receiver, another communication method for conducting data write/read operations based on an HTTP (Hypertext Transfer Protocol) and still another communication method for conducting data transferring operation based on a FTP (File Transfer Protocol).

7. The management system of claim 5,
wherein the first communication method is a communication method for exchanging E-mails between a sender and a receiver, while the second communication method is another communication method for conducting data write/read operations based on an HTTP (Hypertext Transfer Protocol); and
wherein the common data is such data that is in conformity with an E-mail format.

8. The management system of claim 5,
wherein at least one of the first data processing section and the second data processing section is configured as a module.

9. A management method to be employed in a management system, which includes: a first managed apparatus that conducts a data communicating operation in a first communication method; a second managed apparatus that conducts another data communicating operation in a second communication method; a management apparatus that is applicable for both the first communication method and the second communication method, and that employs management data to manage at least one or both of the first managed apparatus and the second managed apparatus; and a communication network through which the first managed apparatus, the second managed apparatus and the management apparatus are coupled to each other;
wherein the management method to be implemented by the management apparatus comprises:
creating the management data;
converting the management data to common data having such a format that conforms with the first communication method and that is available for the second communication method;
converting the common data to communication data having such a format that conforms with the second communication method; and
transmitting the common data to the first managed apparatus, while transmitting the communication data to the second managed apparatus.

10. The management method of claim 9,
wherein the management method to be implemented by the first managed apparatus comprises:
receiving the common data;
converting the common data to the management data, and then, recording management information of the first managed apparatus itself into the management data so as to create revised management data;
converting the revised management data to revised common data; and
transmitting the revised common data to the management apparatus; and
wherein the management method to be implemented by the management apparatus further comprises:
receiving the revised common data;
converting the revised common data to the revised management data; and
acquiring the management information from the revised management data.

11. The management method of claim 9,
wherein the management method to be implemented by the second managed apparatus comprises:
receiving the communication data;
converting the communication data to the management data, and then, recording management information of the second managed apparatus itself into the management data so as to create revised management data;
converting the revised management data to revised communication data; and
transmitting the revised communication data to the management apparatus; and
wherein the management method to be implemented by the management apparatus further comprises:
receiving the revised communication data;
converting the revised communication data to revised common data;
converting the revised common data to the revised management data; and
acquiring the management information from the revised management data.

12. The management method of claim 9,
wherein each of the first communication method and the second communication method is any one of a communication method for exchanging E-mails between a sender and a receiver, another communication method for conducting data write/read operations based on an HTTP (Hypertext Transfer Protocol) and still another communication method for conducting data transferring operation based on a FTP (File Transfer Protocol).

13. The management method of claim 9,
wherein the first communication method is a communication method for exchanging E-mails between a sender and a receiver, while the second communication method is another communication method for conducting data write/read operations based on an HTTP (Hypertext Transfer Protocol); and
wherein the common data is such data that is in conformity with an E-mail format.

14. A management method to be employed in a management system, which includes: a first management apparatus that conducts a data communicating operation in a first communication method; a second management apparatus that conducts another data communicating operation in a second communication method; a managed apparatus that is applicable for both the first communication method and the second communication method, and that is managed by management data employed by at least one or both of the first management apparatus and the second management apparatus; and a communication network through which the first management apparatus, the second management apparatus and the managed apparatus are coupled to each other;
wherein the management method to be implemented by the managed apparatus comprises:
receiving common data, having such a format that conforms with the first communication method and that is available for the second communication method, from the first management apparatus;
converting the common data to the management data created by the first management apparatus;
recording management information of the managed apparatus itself into the management data so as to create revised management data;
converting the revised management data to revised common data; and
transmitting the revised common data to the first management apparatus; and
wherein the management method to be implemented by the first management apparatus comprises:
receiving the revised common data
converting the revised common data to the revised management data; and
acquiring the management information from the revised management data.

15. The management method of claim 14,
wherein each of the first communication method and the second communication method is any one of a communication method for exchanging E-mails between a sender and a receiver, another communication method for conducting data write/read operations based on an HTTP (Hypertext Transfer Protocol) and still another communication method for conducting data transferring operation based on a FTP (File Transfer Protocol).

16. The management method of claim 14,
wherein the first communication method is a communication method for exchanging E-mails between a sender and a receiver, while the second communication method is another communication method for conducting data write/read operations based on an HTTP (Hypertext Transfer Protocol); and
wherein the common data is such data that is in conformity with an E-mail format.

17. A management method to be employed in a management system, which includes: a first management apparatus that conducts a data communicating operation in a first communication method; a second management apparatus that conducts another data communicating operation in a second communication method; a managed apparatus that is applicable for both the first communication method and the second communication method, and that is managed by management data employed by at least one or both of the first management apparatus and the second management apparatus; and a communication network through which the first management apparatus, the second management apparatus and the managed apparatus are coupled to each other;
wherein the management method to be implemented by the managed apparatus comprises:
receiving communication data, having such a format that conforms with the second communication method, from the second management apparatus;
converting the communication data to common data, having such a format that conforms with the first communication method and that is available for the second communication method;
converting the common data to the management data created by the second management apparatus;
recording management information of the managed apparatus itself into the management data so as to create revised management data;
converting the revised management data to revised common data;
converting the revised common data to revised communication data; and
transmitting the revised communication data to the second management apparatus; and
wherein the management method to be implemented by the second management apparatus comprises:
receiving the revised communication data;
converting the revised communication data to the revised management data; and
acquiring the management information from the revised management data.

18. The management method of claim 17,
wherein each of the first communication method and the second communication method is any one of a communication method for exchanging E-mails between a sender and a receiver, another communication method for conducting data write/read operations based on an HTTP (Hypertext Transfer Protocol) and still another communication method for conducting data transferring operation based on a FTP (File Transfer Protocol).

19. The management method of claim 17,
wherein the first communication method is a communication method for exchanging E-mails between a sender and a receiver, while the second communication method is another communication method for conducting data write/read operations based on an HTTP (Hypertext Transfer Protocol); and
wherein the common data is such data that is in conformity with an E-mail format.

20. A computer readable storage medium storing a computer executable program to be executed in a management apparatus included in a management system, which comprises: a first managed apparatus that conducts a data communicating operation in a first communication method; a second managed apparatus that conducts another data communicating operation in a second communication method; the management apparatus that is applicable for both the first communication method and the second communication method, and that employs management data to manage at least one or both of the first managed apparatus and the second managed apparatus; and a communication network through which the first managed apparatus, the second managed apparatus and the management apparatus are coupled to each other, the program being executable by a computer to cause the computer to perform a process comprising:
conducting a conversion processing between the management data and common data having such a format that conforms with the first communication method and that is available for the second communication method; and
conducting another conversion processing between the common data and communication data having such a format that conforms with the second communication method.

21. A computer readable storage medium storing a computer executable program to be executed in a managed apparatus included in a management system, which comprises: a first management apparatus that conducts a data communicating operation in a first communication method; a second management apparatus that conducts another data communicating operation in a second communication method; the managed apparatus that is applicable for both the first communication method and the second communication method, and that is managed by management data employed by at least one or both of the first management apparatus and the second management apparatus; and a communication network through which the first management apparatus, the second management apparatus and the managed apparatus are coupled to each other, the program being executable by a computer to cause the computer to perform a process comprising:
conducting a conversion processing between the management data and common data having such a format that conforms with the first communication method and that is available for the second communication method; and
conducting another conversion processing between the common data and communication data having such a format that conforms with the second communication method.
